(19) United States
(12) Patent Application Publication
(10) Pub. No.: US 2023/0261347 A1
(43) Pub. Date: Aug. 17, 2023

(54) ELECTROCHEMICAL CELL WITH SOLID ELECTROLYTE COMPRISING A REFERENCE ELECTRODE

(71) Applicants: CENTRE NATIONAL DE LA RECHERCHE SCIENTIFIQUE, Paris (FR); SORBONNE UNIVERSITE, Paris (FR); COLLEGE DE FRANCE, Paris (FR)

(72) Inventors: Romain DUGAS, PARIS (FR); Jean-Marie TARASCON, PARIS (FR)

(21) Appl. No.: 18/012,964

(22) PCT Filed: Jun. 29, 2021
(86) PCT No.: PCT/EP2021/067909

§ 371 Date: Dec. 26, 2022

(30) Foreign Application Priority Data
Jun. 30, 2020 (FR) FR2006836

(51) Int. Cl. H01M 50/569; H01M 10/0562

(52) U.S. Cl. CPC H01M 50/569; H01M 10/0562; H01M 2300/0068

(57) ABSTRACT

An electrochemical cell, includes a positive electrode and a negative electrode arranged face to face in the cell body, and a stack of electrolyte layers interposed between the positive electrode and the negative electrode. The stack of electrolyte layers comprises a first layer of solid electrolyte arranged at one end of the positive electrode, a second layer of solid electrolyte arranged at one end of the negative electrode, a composite powder layer interposed between the first layer and the second layer, the composite powder layer comprising an electrolyte powder and an electroactive material powder serving as a reference electrode for the electrochemical cell.

The invention relates to an electrochemical cell, to a composite powder intended to be interposed between two layers of solid electrolyte in an electrochemical cell, to a process for preparing a composite powder, and to a process for assembling an electrochemical cell.

In the present patent application, a device consisting of two electrodes separated by an electrolyte, which are the site of redox reactions, will be referred to as an “electrochemical cell”, and apparatus composed of one or more electrochemical cells will be referred to as a “battery”.

For the study and development of novel electrochemical cells, a third electrode, commonly known as the reference electrode, is needed to independently study the electrochemical reactions taking place at the anode (negative electrode) and at the cathode (positive electrode). This third electrode remains at a constant potential during the functioning of the cell and is a reference relative to which the anode and cathode potentials are measured. The contribution of each electrode to the overall performance of the cell can thus be studied.

With the development of electric and hybrid vehicles, it is sought to design batteries with an increasingly high energy storage capacity in an increasingly limited volume. However, with a higher energy density, more safety issues arise, in particular in the case of lithium-ion batteries using liquid electrolytes that are toxic, flammable and volatile. In this context, substantial research efforts are currently devoted to the development of all-solid-state batteries (also known as solid-state batteries), which are based on a solid lithium ion conductor as electrolyte instead of a liquid. Solid electrolytes also constitute a stronger physical barrier against short circuits.

Several problems arise when a reference electrode is placed in a solid-electrolyte electrochemical cell.

Specifically, it should be recalled that solid-electrolyte electrochemical cells are generally in the form of pellets assembled between two pistons sliding inside a cylinder, and subjected to a high pressure during assembly (of the order of one tonne per cm²). The introduction of a third electrode into such a cell is thus rendered complicated by the pressure required to assemble the cell, which may break a thin wire such as that usually used as reference electrode in liquid-electrolyte cells.

Moreover, assuming that the third electrode withstands the pressure exerted, it is also appropriate, when assembling the cell, to extract from the cell the wire acting as a reference electrode, in order to make electrical contact, either through a tiny hole in the edge of the cylinder, or between the cylinder and one of the pistons, which is also tricky given the pressure exerted.

Finally, if it is desired more particularly to study the electrode/electrolyte interfaces, use of the electrochemical impedance spectroscopy technique, described notably in [Costard2017] is then recommended. This technique involves additional constraints, notably concerning the symmetry of the electrochemical cell, including the symmetry of the reference electrode, to avoid the appearance of artefacts on the impedance spectra. In the abovementioned article, a reference electrode in the form of a grid enables electron conduction on a section of the cell located between the positive and negative electrodes, while the openings in the grid allow ion conduction between the two electrodes. However, this type of arrangement cannot be transposed to a solid-electrolyte cell, for the reasons of high pressure mentioned previously.

The scientific literature contains a few articles proposing the addition of a reference electrode to a solid-electrolyte cell.

In [Nam2018], two configurations are reported, which allow the potential of each electrode to be monitored during galvanostatic (i.e. constant current) cycles. The first configuration, shown in scheme 2a of the article, consists of a point reference electrode arranged on the side of the electrolyte without being fully integrated into the cell. In the second configuration, shown in scheme 2b of the article, the reference electrode is placed above the cathode, the current collector of which must be meticulously pierced. The reference electrodes are made of lithium or Li_{0.5}In alloy. In both configurations, the reference electrode is added after assembly of the anode and the cathode with the electrolyte. The configurations resulting therefrom do not allow for distortion-free impedance measurements, the first configuration having low symmetry (causing artefacts to appear in the impedance spectra) and the second configuration positioning the reference electrode above the cathode rather than between anode and cathode.

In [Kasemchainan2019], the three-electrode cell that is used has an electrolyte which is of larger diameter than the working electrodes and a smaller reference electrode is placed next to a working electrode on the electrolyte pellet. All three electrodes are made of lithium. In this case also, the geometry is not ideal for impedance measurements due to its asymmetry.

In [Schlenker2020], the reference electrode is a gold-plated tungsten wire inserted into the electrolyte before densification. This configuration allows correct impedance spectra to be obtained, due to the fact that the reference electrode passes through the cell (symmetrical configuration). The problem with using a gold-plated tungsten electrode is, however, that the potential is not well defined and risks being unstable in the long term, since the reference material does not contain any lithium. To improve it, it would be possible to combine gold with lithium, but this solution is known for not being systematically reliable, as reported in [Pritzl2018]. Indeed, with this configuration, only a very small amount of lithium can be present in the reference electrode, and parasitic reactions taking place in the cell may thus be sufficient to delithiate the reference electrode.

The invention is thus directed toward providing a solid-electrolyte electrochemical cell, allowing both long-term monitoring of the potential of the two electrodes and distortion-free impedance measurements.

One subject of the invention is thus an electrochemical cell, comprising a positive electrode and a negative electrode arranged face to face in the cell body, a stack of electrolyte layers interposed between the positive electrode and the negative electrode, the stack of electrolyte layers comprising a first layer of solid electrolyte arranged at one end of the positive electrode, a second layer of solid electrolyte arranged at one end of the negative electrode, a composite powder layer interposed between the first and second layers, the composite powder layer comprising an electrolyte powder and an electroactive material powder serving as a reference electrode for the electrochemical cell.

Advantageously, the electrochemical cell also comprises a current collector arranged on at least part of the periphery of the composite powder layer and in electrical contact therewith.

Advantageously, the current collector is an annular collector, arranged around the entire periphery of the composite powder layer.

Advantageously, the composite powder layer is arranged symmetrically relative to an axis coinciding with the stacking direction of the electrolyte layers and passing through the center of the cell.

Advantageously, the first electrolyte layer, the second electrolyte layer and the electrolyte powder comprise a sulfide.

Advantageously, the sulfide is βLi₃PS₄(β-LiPS).

Advantageously, the electroactive material powder comprises lithium, or an alloy based on lithium and indium.

Advantageously, the alloy based on lithium and indium is LiₓIn, where 0<x<1, and preferably Li_{0.5}In.

Advantageously, the electroactive material powder comprises Li₄Ti₅O₁₂ or Li₇Ti₅O₁₂ (LTO).

Advantageously, the negative electrode and the electroactive material powder are of identical composition.

The invention also relates to a composite powder intended to be interposed between two solid electrolyte layers in an abovementioned electrochemical cell, the composite powder comprising an electrolyte powder and an electroactive material powder serving as a reference electrode for the electrochemical cell.

The invention also relates to a process for preparing the abovementioned composite powder, in which the electrolyte powder comprises β-Li₃PS₄ (β-LPS), the electroactive material powder comprises LiₓIn, where 0<x<1, the process comprising the following steps:

a1) plating, by cold colamination, under a protective atmosphere, of a lithium foil between two indium foils in mass proportions corresponding to the composition LiₓIn, followed by folding of the product thus obtained;
b1) repeating the preceding step a number of times, until a stable state of the product is obtained;
c1) milling the product with the electrolyte powder in mass proportions of 50% to 70% electroactive material powder and 30% to 50% electrolyte powder, preferably 60% electroactive material powder and 40% electrolyte powder, until a homogeneous powder is obtained.

The invention also relates to a process for preparing the abovementioned composite powder, the electrolyte powder comprising β-Li₃PS₄ (β-LPS), and the electroactive material powder comprising Li₄₊ₓTi₅O₁₂ (LTO), where 0<x<1, the process comprising the following steps:

a2) mixing Li₄Ti₅O₁₂ powder with carbon black, in a ratio of 3:1 by mass, to form an LTO:C powder;

b2) reducing a portion of the LTO:C powder in a liquid electrolyte cell with a lithium counter electrode, until an Li₇Ti₅O₁₂:C powder is obtained;

c2) rinsing and centrifuging the Li₇Ti₅O₁₂:C powder with dimethyl carbonate;

d2) mixing the powder obtained in step c2) with an unreduced portion of the LTO:C powder, in proportions corresponding to the composition Li₄₊ₓTi₅O₁₂, and 60% by mass of electrolyte powder.

The invention also relates to a process for assembling an electrochemical cell comprising an insulating cell body equipped with a current collector, a first piston and a second piston, the process also comprising the following steps:

a) inserting the second piston into the cell body so that it is flush with the current collector, introducing the abovementioned composite powder, followed by an electrolyte pellet, and applying pressure between the two pistons, so that the composite powder is in electrical contact with the current collector, while at the same time avoiding any slippage of the composite powder in the cell body in the event of removal of at least one of the two pistons;
b) turning the cell body over, removing the second piston, adding electrolyte powder, inserting the second piston into the cell body 10, and applying pressure between the two pistons so as to compact the electrolyte powder;
c) removing the second piston, depositing a positive electrode electroactive material powder in the cell body, inserting the second piston into the cell body, turning the cell body over, removing the first piston, depositing a negative electrode electroactive material powder in the cell body, inserting the first piston into the cell body, and applying pressure between the two pistons so as to compact the two electroactive material powders.

Other features, details and advantages of the invention will emerge on reading the description made with reference to the appended drawings, which are given as examples and which represent, respectively:

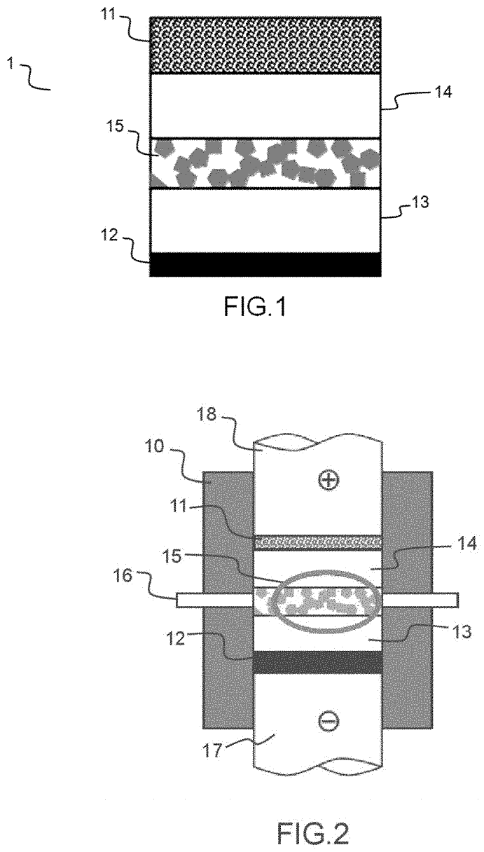

FIG. 1 represents a view in cross section of an electrochemical cell according to the invention;

FIG. 2 represents a view in cross section of an electrochemical cell according to the invention, housed in an insulating cell body;

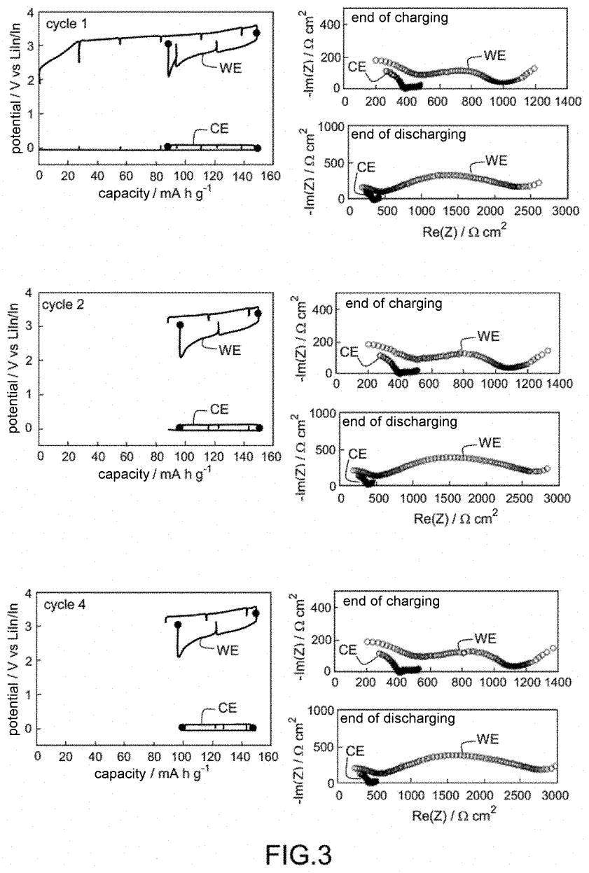

FIG. 3 represents the potential of each electrode, and also the impedances at the end of charging and discharging, for different galvanostatic cycles, with the following electrode triplet: NMC/Li_{0.5}In/Li_{0.5}In;

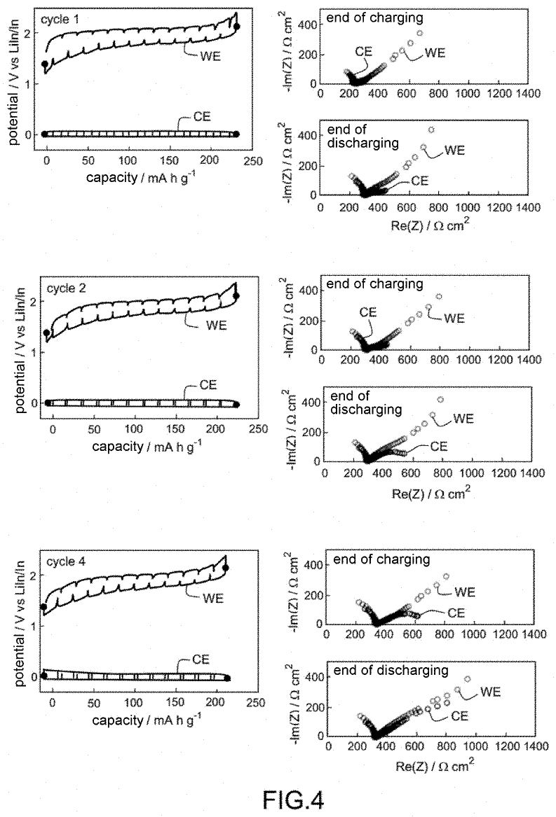

FIG. 4 represents the potential of each electrode, and also the impedances at the end of charging and discharging, for different galvanostatic cycles, with the following electrode triplet: LTFS/Li_{0.5}In/Li_{0.5}In;

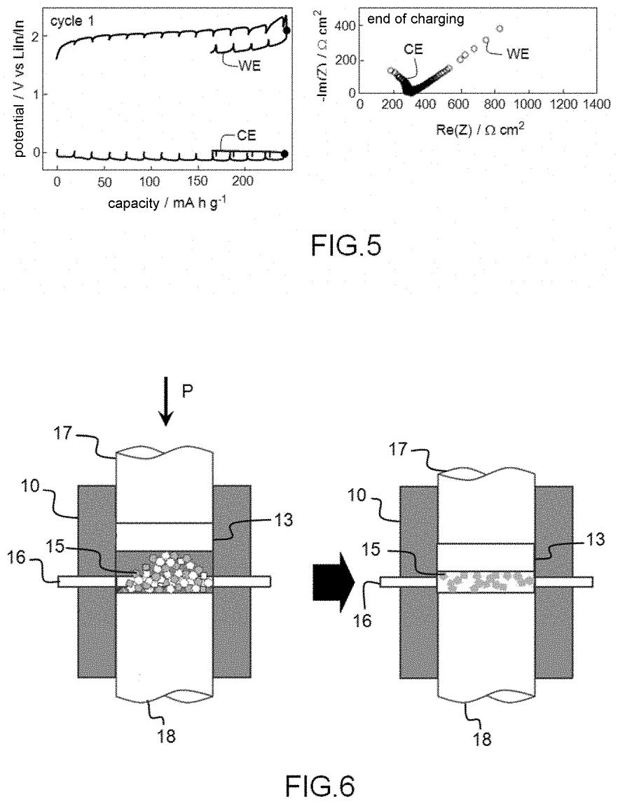

FIG. 5 represents the potential of each electrode, and also the impedances at the end of charging, for a galvanostatic cycle, with the following electrode triplet: LTFS/LTO/Li_{0.5}In;

FIGS. 6, 7 and 8 illustrate the different steps of the process for assembling an electrochemical cell according to the invention.

FIG. 1 represents a view in cross section of the electrochemical cell according to the invention. The cell 1 is composed of a positive electrode 11 and a negative electrode 12.

In the present patent application, it will be considered that the positive electrode 11 is the working electrode (WE), i.e. the electrode on which the reaction of interest takes place, and the negative electrode 12 is the counter electrode (CE). Depending on whether the reaction on the electrode is a reduction or an oxidation, the working electrode is thus called the cathode or the anode, respectively.

In general, the terms “working electrode” and “counter electrode” are used rather for a test cell which serves to study the properties of the working electrode, where the counter electrode only serves to supply the current. For a complete electrochemical cell, such as one which may be found in an on-board application (for example in a vehicle), this distinction is no longer relevant and the terms “positive electrode” and “negative electrode” are used instead. The convention for electrochemical cells is to use the term “cathode” for the positive electrode and “anode” for the negative electrode, although these terms are only correct when the cell is discharging.

Advantageously, the positive electrode 11 comprises Vapor-Phase Growth Carbon Fibers (VGCF).

According to one variant, the positive electrode 11 comprises carbon black, in particular “Super-P” (registered trademark) carbon black.

The carbon fibers, and the carbon black, serve to increase the electron conductivity of the positive electrode composite, so as to improve the capacitance and power.

The electrodes are spaced apart by a stack of electrolyte layers (13, 14, 15) intended for ion transfer between the electrodes.

The stack of electrolyte layers (13, 14, 15) consists of three layers, namely two solid electrolyte layers (13, 14) and a composite powder layer (15) interposed between the two solid electrolyte layers (13, 14).

The composite powder layer 15 itself comprises an electrolyte powder and an electroactive material powder which serves as a reference electrode for the electrochemical cell. The term “electroactive material which serves as a reference electrode for the electrochemical cell” means a material whose potential is constant during the use of the cell.

The innovative aspect thus comes from the use of a composite powder as a reference electrode located in the middle of the cell in the form of a “slice”. The proportions of electrolyte powder and electroactive material powder are determined so that there is both electron conduction to a current collector arranged at the periphery of the composite powder layer 15 (constant voltage), and ion conduction between the working electrode and the counter electrode.

The use of a composite powder in an all-solid state battery exploits the fact that the electrolyte is solid to dispense with the presence of the current collector in the middle of the battery and the constraints arising therefrom, while at the same time having a reference electrode placed at the heart of the battery. The cell geometry can be entirely axisymmetric to provide the best conditions for impedance measurements. The electrical contact on the reference electrode can be made at any point on its periphery or all around it using a ring-shaped current collector.

Instead of being in the form of a wire, the electroactive reference material is used in the form of a powder and mixed with the solid electrolyte. After cold pressing, the reference electrode takes the form of a layer in the middle of the cell, located between the two electrolyte layers (13, 14).

The mass distribution of the first electrolyte layer 13, the second electrolyte layer 14 and the composite powder layer 15 may be identical (one third for each layer), but this condition is not necessary. It is thus possible to lighten one of the electrolyte layers.

FIG. 2 shows the electrochemical cell 1, arranged in a cell body 10. The cell consists of a hollow insulating body 10, the shape of which corresponds to that of the pistons (17, 18) arranged on either side of the electrodes. For example, the cell body may be cylindrical, as may the pistons (17, 18). The pistons may be made of stainless steel. A current collector 16 is arranged on at least part of the periphery of the composite powder layer 15. The composite powder layer 15 is advantageously arranged symmetrically relative to the stacking axis of the layers, and as the composite powder has a good electron conductivity, contact can be made on only part of the circumference without the risk of distortions appearing. It is also possible to opt for a current collector arranged around the entire periphery of the composite powder layer 15. The current collector 16 can thus be annular, if the other parts are cylindrical.

The height of the composite powder layer 15 must be less than the sum of the heights of the two electrolyte layers (13, 14) and of the composite powder layer 15, with a safety margin, to ensure that the composite powder layer 15 is indeed flush with the current collector and to avoid any risk of short-circuiting.

The electrolyte used in the composite powder must be of the same type (oxide type or sulfide type) as that used in the other electrolyte layers (13, 14). It is preferable for the materials to be entirely identical. The electrolyte used may advantageously be β-Li₃PS₄ (β-LPS), which has high ion conductivity (of the order of 1.6×10⁻⁴ S·cm⁻¹ at room temperature). This material moreover has good stability when coupled to lithium-based anodes.

As a variant, the electrolyte may be Li₆PS₅Cl. This component has ion conductivity that is about ten times greater than that of β-LPS, which leads directly to higher capacities in terms of energy density and power. Li₆PS₅Cl can be found, for example, in argyrodite.

The material chosen for the electroactive material powder should preferably have a sufficiently large plateau with which the potential variation of the positive or negative electrode material would be compared. Indeed, having a material with a complex electrochemical signature at the reference electrode would complicate the characterization of the electrodes.

The LiₓIn alloy, for 0<x<1, has a plateau at 0.622 V vs. Li⁺/Li, making it a suitable reference material for the electroactive material powder.

Two-phase systems will advantageously be used for the electroactive material acting as reference electrode, in particular In/LiIn or Li₄Ti₅O₁₂/Li₇Ti₅O₁₂. It is also possible to use lithium directly.

Thus, the composite powder may comprise a mixture of β-LPS and Li_{0.5}In.

The electrochemical cell according to the invention does not require any specific material as positive electrode, one of the objectives of the three-electrode cell being precisely to study the behavior and performance of this electrode in the laboratory, notably for experimental purposes.

Similarly, the choice of the negative electrode is dictated more by the general operating constraints of all-solid-state batteries than by the use of a three-electrode assembly. As a general rule, it is important to ensure that the negative electrode can accommodate lithium if the positive electrode is a source of lithium and vice versa.

In-Li alloy can be used as a negative electrode in an all-solid state cell. In particular, it is advantageous, for practical reasons of experimental preparation, to use the same powder for the negative electrode and for the electrolyte material.

As a variant, the negative electrode 12 may exclusively comprise lithium, thereby increasing the cell voltage and decreasing the mass for more energy.

FIGS. 3, 4 and 5 show different galvanostatic cycles, for different electrode triplets. Three configurations were tested, each triplet designating, in the following order, the positive electrode, the electroactive material acting as the reference electrode, and the negative electrode. NMC/Li_{0.5}In/Li_{0.5}In in FIG. 3, LTFS/Li_{0.5}In/Li_{0.5}In in FIG. 4 and LTFS/LTO/Li_{0.5}In in FIG. 5. In all the configurations tested, the composite powder also comprises β-LPS as electrolyte material, although it may be envisioned to use another material.

NMC corresponds to the following compound: Ni_{0.6}Mn_{0.2}Co_{0.2}O₂

LTFS corresponds to the following compound: Li_{1.13}Ti_{0.57}Fe_{0.3}S₂

LTO corresponds to the following compound: Li₄Ti₅O₁₂

The galvanostatic cycles are performed by applying a constant current between the positive electrode (denoted WE in FIGS. 3 to 5) and the negative electrode (denoted CE in FIGS. 3 to 5). When the potential of the positive electrode reaches a material-dependent limit value, the direction of the current is reversed. The graphs plot the potentials of the positive and negative electrodes relative to the reference electrode (denoted RE in FIGS. 3 to 5) as a function of the capacity (in the “battery” sense of the word, i.e. the integral of i.dt) per unit mass of electroactive material in the positive electrode. Ideally, consecutive or virtually consecutive cycles (cycles 1, 2 and 4 in FIGS. 3 and 4) are superimposed without the potential falling or shifting along the x-axis.

The current used was 13.8 mA/g for the example in FIGS. 3, and 9.25 mA/g for the example in FIG. 4. The composite powders consist of 70% electroactive material and 30% solid electrolyte by mass and are prepared by mechanical milling for 20 minutes (Spex type mill).

Impedance measurements were taken at regular intervals during galvanostatic charging and discharging, every two hours. These measurements consist in applying a sinusoidal voltage signal between the positive electrode and the reference electrode around their equilibrium voltage, and in measuring the current between the positive electrode and the negative electrode, which is also sinusoidal and of the same frequency but out of phase relative to the voltage. The impedance, which is the ratio of voltage to current, is thus a complex quantity. As these measurements are taken around an equilibrium point, it is necessary to allow the cell to relax before taking the measurement, which is reflected by the vertical lines on the galvanostatic cycles. The impedance was measured for frequencies ranging from 200 kHz to 10 mHz and an amplitude of 50 mV. Only the end-of-charge and end-of-discharge impedances are plotted on the right-hand side of each of the FIGS. 3 to 5 (indicated by solid discs on the galvanostatic cycles) although multiple intermediate measurements were taken. The impedance spectra are plotted in the form of Nyquist diagrams, on which the imaginary part of the impedance is plotted against its real part. The frequency that does not appear explicitly decreases as the real part increases.

The results obtained first of all show good decoupling between the curves of the positive and negative electrodes, which makes it possible to soundly characterize each of the materials that are active at the positive and negative electrodes.

The second and third configurations (LTFS sulfide positive electrode) have a capacity four times higher than the first configuration, with excellent reversibility. The impedance for the second and third configurations remains of the same order of magnitude throughout the cycling process. Variations may, however, be observed, notably at the end of discharging, where an intermediate frequency contribution tends to increase. The impedance is moreover lower for the second and third configurations, without really increasing at the end of charging.

In the three configurations, the impedance of the negative electrode is markedly more stable, although it also tends to increase. The negative electrode is not perfectly stable either, which can be seen both in the impedance measurements and in the galvanostatic cycles, where the polarization tends to increase during the cycles. This is particularly visible in the right-hand side of FIG. 4, where the curve of the negative electrode tends to open up.

Without the presence of the composite powder layer, only the point-to-point sum of the two impedance curves in the same graph could be measured, leaving the attribution of variations to either of the electrodes open to question. Similarly, without the presence of the composite powder layer, only the polarization increase could be observed, without it being possible to attribute it to the positive or negative electrode.

Finally, the use of LTO as the electroactive material powder (FIG. 5) gives similar results with a shift of 940 mV on the potential scale, which corresponds to the difference between the equilibrium potential of the Li/LiIn and Li₄Ti₅O₁₂/Li₇Ti₅O₁₂ systems. Consequently, the Li_{0.5}In negative electrode, which works at around 0 V relative to a reference of the same nature, is in the negative potentials relative to an LTO reference. It shows higher polarization than that of the cells used previously, which is attributable to a batch change. Since impedance measurements only involve variations around an equilibrium point, they are not affected by the absolute value of the potential. The spectra obtained with either type of reference are thus similar.

The invention also relates to a composite powder intended to be interposed between two solid electrolyte layers in an electrochemical cell. The composite powder comprises an electrolyte powder and an electroactive material powder which serves as a reference electrode for the electrochemical cell. The use of such a powder in an electrochemical cell thus allows easy interaction with an external current collector.

The invention also relates to a process for preparing a composite powder. Two embodiments may be envisioned, depending on whether the composite powder comprises LiₓIn or Li₄₊ₓTi₅O₁₂ (LTO) (where 0<x<1), corresponding, respectively, to the measurements in FIGS. 3 and 4, on the one hand, and in FIG. 5, on the other hand. In both embodiments, the composite powder also comprises β-Li₃PS₄ (β-LPS), as the electrolyte material.

According to a first embodiment, the composite powder comprises LiₓIn (where 0<x<1), and the process comprises the following steps:

The electroactive material powder which serves as a reference electrode is first prepared. In a first step a1), a lithium foil is plated by cold colamination, under a protective atmosphere, between two indium foils in mass proportions corresponding to the LiₓIn composition, and the product thus obtained is then folded. The colamination may be performed, for example, by means of a glass tube on a polyethylene sheet.

The colamination and folding are repeated a number of times until a stable state of the product is obtained (step b1). Specifically, after a few repetitions, the material becomes brittle, which is the sign that the alloy has been formed. The material is initially soft and spreads out in a rather paste-like manner, whereas once the alloy has formed, it starts to crack during lamination. It is also less bright. The successive colaminations increase the exchange surface between the lithium and indium foils, and accelerate the process for obtaining stability of the LiₓIn alloy.

In a third step c1), the product obtained in the preceding step is milled with the electrolyte powder in the following mass proportions: from 50% to 70% electroactive material powder and from 30% to 50% electrolyte powder, and preferably 60% electroactive material powder and 40% electrolyte powder, until a homogeneous powder is obtained, which is used as is for the assembly of the battery.

All these operations can be performed in a glove box, under a controlled atmosphere, for example of argon.

According to a second embodiment, the electroactive material powder comprises Li₄₊ₓTi₅O₁₂ (LTO), where 0<x<1, and the composite powder is prepared in the following manner.

In a first step a2), Li4Ti5O12 powder is mixed with an electron conductor, preferably carbon black, in a ratio of 3:1 by mass to form an LTO:C powder.

In a second step b2), part of the powder obtained in the preceding step is reduced in a liquid electrolyte cell facing a lithium counter electrode so as to form the Li₇Ti₅O₁₂ phase. The liquid electrolyte may be LP30.

In a third step c2), when the reduction mentioned in step b2) is complete, the Li₇Ti₅O₁₂:C powder is recovered, rinsed and centrifuged with dimethyl carbonate. The centrifugation may be repeated several times (for example three times). This powder is mixed (step d2) with the part of the LTO:C powder which has not been reduced; the mixing is performed in proportions corresponding to the composition Li₄₊ₓTi₅O₁₂, and 60% electrolyte by mass.

The preparation process according to the first embodiment is particularly advantageous, since it does not require the assembly of a liquid electrolyte cell to prepare one of the two phases of the reference material. It also does not require the addition of an electron conductor (carbon black) since lithium and indium are metallic conductors.

The invention also relates to a process for assembling an electrochemical cell, illustrated by FIGS. 6, 7 and 8.

An insulating cell body 10 is provided, in which a current collector 16 is placed. The cell body 10 may be cylindrical, and the current collector 16 annular. A first piston 17 and a second piston 18 are also provided to serve as support for the negative electrode and the positive electrode, respectively.

In a first step a), the second piston 18 is inserted into the cell body so that it is flush with the current collector 16. The composite powder 15 defined previously is poured into the cell body 10, and an electrolyte pellet 13 is then placed in the cell body 10. The mass of the composite powder is 45 mg for the Li_{0.5}In:β-LPS powder or 35 mg for the less dense LTO:C:β-LPS powder for a cell body 10 which is 8 mm in diameter.

Prior to the assembly of the cell, a pellet of electrolyte 13, of the same diameter as the diameter of the pistons, will thus have been prepared. To obtain a pellet 8 mm in diameter, a pressure of 1 t.cm⁻² is applied to 45 mg of electrolyte material, for example β-LPS.

Pressure is then applied between the two pistons (17, 18), so that the composite powder 15 is in electrical contact with the current collector 16, while at the same time avoiding any slippage of the composite powder 15 in the cell body 10 in the event of removal of at least one of the two pistons (17, 18), and in particular in the event of removal of the first piston 17 when the cell body 10 is turned over in the next step. The pressure between the two pistons is maintained at 1 t/cm² for three minutes. At the end of this step, the composite powder is densified and is located at its current collector.

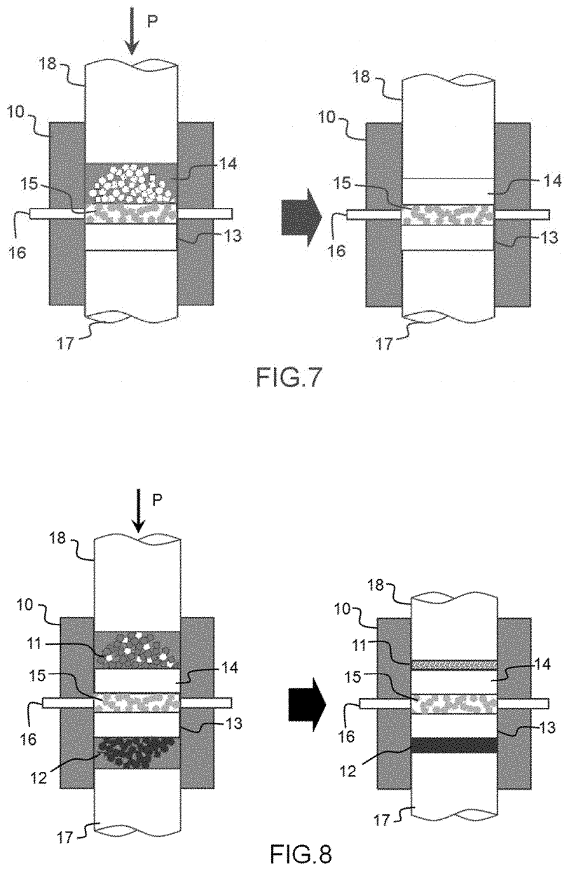

In a second step b), illustrated in FIG. 7, the cell body 10 is turned over. The first piston 17 is now in the lower position. The second piston 18 is removed from the cell body 10. An electrolyte powder 14 is poured into the cell body 10. For example, 40 mg of β-LPS can be poured in. This mass can be reduced, so as to limit the ohmic drop between the reference electrode and the positive electrode.

The second piston 18 is then reinserted in the cell body 10, and pressure is applied between the two pistons (17, 18) so as to compact the electrolyte powder 14. A pressure of 1 T/cm² may be applied for a few seconds.

In the last step c), illustrated in FIG. 8, the second piston 18 is removed, the positive electrode electroactive material 11 (for example NMC or LTFS) is poured in, and the second piston 18 is reinserted in the cell body 10. The cell is turned over (not visible in FIG. 8) and, similarly, the negative electrode material 12 (for example Li_{0.5}In) is poured into the cell body 10. The assembly is then held under such pressure that the two electroactive material powders (14, 15) become compact. For example, a pressure of 4 T/cm² may be applied for 15 minutes.

If a pure lithium electrode is to be used, the electrode, which would not be able to withstand a pressure of 4 T/cm², is not placed in the cell until after the pressure mentioned in step c) has been applied. This problem does not arise for the LTO or Li_{0.5}In electrodes.

The cell 10 can then be placed in a frame maintaining the desired pressure for cycling (in this case 1 T/cm²) and ready for use by making the electrical contacts on the pistons and the annular collector.

All the assembly operations are performed in a glove box.

The assembly process thus makes it possible to obtain good mechanical strength of the various components of the electrochemical cell, with interfaces between the layers allowing good ion conduction from one electrode to the other, while at the same time ensuring electrical conductivity toward the current collector.

As a variant, the process for assembling an electrochemical cell 1 comprises a first step a) comprising two substeps a1) and a2).

The first substep a1) consists in inserting the second piston 18 into the cell body so that it is flush with the current collector 16, introducing composite powder 15, and applying pressure between the two pistons (17, 18), so that the composite powder 15 is in electrical contact with the current collector 16, while at the same time avoiding any slippage of the composite powder 15 in the cell body 10 in the event of removal of at least one of the two pistons (17, 18).

In a second substep a2), the first piston 17 is removed, and an electrolyte powder 13 is added. The second piston 17 is then inserted into the cell body 10, and pressure is applied between the two pistons 17, 18 so as to compact the electrolyte powder 13.

The rest of the process is identical to the abovementioned assembly process. This variant thus does not require the prior preparation of an electrolyte pellet.

The electrochemical cell that is the subject of the invention makes it possible firstly to characterize electrodes on a laboratory scale. Beyond the laboratory scale, the composite powder according to the invention, which has the advantage of not needing to be mechanically supported by a current collector, can also be integrated as an on-line diagnostic element in batteries. For the purpose of an on-board application, with high volume constraints, it may be envisioned to approach the percolation threshold by varying the proportion of electroactive material in the composite powder, so as to affect the transport of ions between the anode and the cathode as little as possible.

For the purpose of an on-board application, it may also be sought to significantly reduce the amount of composite powder, so as to affect the transport of ions between the anode and the cathode as little as possible. It may also be envisioned to interpose the composite powder layer only on the inner periphery of the cell, for example in the shape of a ring or a rectangle depending on the geometry of the battery.

In the context of an on-board use, the pistons, which serve to assemble the cell, can be replaced with lighter and less bulky current collectors.

### LIST OF REFERENCES CITED

[Costard2017]: “Three-Electrode Setups for Lithium-Ion Batteries II. Experimental Study of Different Reference Electrode Designs and Their Implications for Half-Cell Impedance Spectra” (J. Costard et al.), Journal of the Electrochemical Society, 164 (2) A80-A87 (2017)

[Nam2018]: “Diagnosis of failure modes for all-solid-state Li-ion batteries enabled by three-electrode cells” (Young Jin Nam et al.), Mater. Chem. A, 2018, 6, 14867

[Kasemchainan2019]: “Critical stripping current leads to dendrite formation on plating in lithium anode solid-electrolyte cells” (Jitti Kasemchainan et al.), Nature Materials, Vol. 18, October 2019, 1105-1111

[Schlenker2020]: “Understanding the Lifetime of Battery Cells Based on Solid-State Li6PS5Cl Electrolyte Paired with Lithium Metal Electrode” (Ruth Schlenker et al.), ACS Appl. Mater. Interfaces, April 2020

[Pritz12018]: “An Analysis Protocol for Three-Electrode Li-Ion Battery Impedance Spectra: Part II. Analysis of a Graphite Anode Cycled vs. LNMO” (Daniel Pritzl et al.), Journal of the Electrochemical Society, 165 (10) A2145-A2153 (2018)

1. An electrochemical cell, comprising a positive electrode and a negative electrode arranged face to face in the cell body, a stack of electrolyte layers interposed between the positive electrode and the negative electrode, wherein the stack of electrolyte layers comprises a first layer of solid electrolyte arranged at one end of the positive electrode, a second layer of solid electrolyte arranged at one end of the negative electrode, a composite powder layer interposed between the first layer and the second layer, the composite powder layer comprising an electrolyte powder and an electroactive material powder serving as a reference electrode for the electrochemical cell.

2. The electrochemical cell as claimed in claim 1, also comprising a current collector arranged on at least part of the periphery of the composite powder layer and in electrical contact therewith.

3. The electrochemical cell as claimed in claim 2, wherein the current collector is an annular collector, arranged around the entire periphery of the composite powder layer.

4. The electrochemical cell as claimed in claim 1, wherein the composite powder layer is arranged symmetrically relative to an axis coinciding with the stacking direction of the electrolyte layers and passing through the center of the cell.

5. The electrochemical cell as claimed in claim 1, wherein the first electrolyte layer, the second electrolyte layer and the electrolyte powder comprise a sulfide.

6. The electrochemical cell as claimed in claim 5, wherein the sulfide is β-Li₃PS₄ (β-LiPS).

7. The electrochemical cell as claimed in claim 1, wherein the electroactive material powder comprises lithium, or an alloy based on lithium and indium.

8. The electrochemical cell as claimed in claim 7, wherein the alloy based on lithium and indium is LiₓIn, where 0<x<1, and preferably Li_{0.5}In.

9. The electrochemical cell as claimed in claim 1, wherein the electroactive material powder comprises Li₄Ti₅O₁₂ or Li₇Ti₅O₁₂ (LTO).

10. The electrochemical cell as claimed in claim 1, wherein the negative electrode and the electroactive material powder are of identical composition.

11. A composite powder intended to be interposed between two solid electrolyte layers in an electrochemical cell as claimed in claim 1, the composite powder comprising an electrolyte powder and an electroactive material powder serving as a reference electrode for the electrochemical cell.

12. A process for preparing a composite powder as claimed in claim 11, wherein the electrolyte powder comprises β-Li₃PS₄ (β-LPS), and the electroactive material powder comprises LiₓIn, where 0<x<1, the process comprising the following steps:
a1) plating, by cold colamination, under a protective atmosphere, of a lithium foil between two indium foils in mass proportions corresponding to the composition LiₓIn, followed by folding the product thus obtained;
b1) repeating the preceding step a number of times, until a stable state of the product is obtained;
c1) milling the product with the electrolyte powder in mass proportions of 50% to 70% electroactive material powder and 30% to 50% electrolyte powder, preferably 60% electroactive material powder and 40% electrolyte powder, until a homogeneous powder is obtained.

13. A process for preparing a composite powder as claimed in claim 11, wherein the electrolyte powder comprises β-Li₃PS₄ (β-LPS), and the electroactive material powder comprises Li₄₊ₓTi₅O₁₂ (LTO), where 0<x<1, the process comprising the following steps:
a2) mixing Li₄Ti₅O₁₂ powder with carbon black, in a ratio of 3:1 by mass, to form an LTO:C powder;
b2) reducing a portion of the LTO:C powder in a liquid electrolyte cell with a lithium counter electrode, until an Li₇Ti₅O₁₂:C powder is obtained;
c2) rinsing and centrifuging the Li₇Ti₅O₁₂:C powder with dimethyl carbonate;
d2) mixing the powder obtained in step c2) with an unreduced portion of the LTO:C powder, in proportions corresponding to the composition Li₄₊ₓTi₅O₁₂, and 60% by mass of electrolyte powder.

14. A process for assembling an electrochemical cell comprising an insulating cell body equipped with a current collector, a first piston and a second piston, the process also comprising the following steps:
a) inserting the second piston into the cell body so that it is flush with the current collector, introducing the composite powder as claimed in claim 11, followed by an electrolyte pellet, and applying pressure between the two pistons, so that the composite powder is in electrical contact with the current collector, while at the same time avoiding any slippage of the composite powder in the cell body in the event of removal of at least one of the two pistons;
b) turning the cell body over, removing the second piston, adding electrolyte powder, inserting the second piston into the cell body, and applying pressure between the two pistons so as to compact the electrolyte powder;
c) removing the second piston, depositing a positive electrode electroactive material powder in the cell body, inserting the second piston into the cell body, turning the cell body over, removing the first piston, depositing a negative electrode electroactive material powder in the cell body, inserting the first piston into the cell body, and applying pressure between the two pistons so as to compact the two electroactive material powders.

15. A process for assembling an electrochemical cell comprising an insulating cell body equipped with a current collector, a first piston and a second piston, the process also comprising the following steps:
a1) inserting the second piston into the cell body so that it is flush with the current collector, introducing the composite powder as claimed in claim 11, and applying pressure between the two pistons, so that the composite powder is in electrical contact with the current collector, while at the same time avoiding any slippage of the composite powder in the cell body in the event of removal of at least one of the two pistons;
a2) removing the first piston, adding electrolyte powder, inserting the second piston into the cell body, and applying pressure between the two pistons so as to compact the electrolyte powder;
b) turning the cell body over, removing the second piston, adding electrolyte powder, inserting the second piston into the cell body, and applying pressure between the two pistons so as to compact the electrolyte powder;
c) removing the second piston, depositing a positive electrode electroactive material powder in the cell body, inserting the second piston into the cell body, turning the cell body over, removing the first piston, depositing a negative electrode electroactive material powder in the cell body, inserting the first piston into the cell body, and applying pressure between the two pistons so as to compact the two electroactive material powders.
